(19) United States
(12) Patent Application Publication
(10) Pub. No.: US 2012/0048661 A1
(43) Pub. Date: Mar. 1, 2012

(54) ABRASION-RESISTANT DISC BRAKE ROTOR

(75) Inventor: Wayne-Ian Moore, Changhua County (TW)

(73) Assignee: ASHIMA LTD., Changhua County (TW)

(21) Appl. No.: 12/861,841

(22) Filed: Aug. 24, 2010

(51) Int. Cl. F16D 65/12

(52) U.S. Cl. 188/218 XL

(57) ABSTRACT

An abrasion-resistant disc brake rotor includes a pair of friction rings made of metal. Each friction ring has a plurality of ventilating holes annularly defined therein. At least one of the ventilating holes has a pair of buckles correspondingly extending from an inner periphery thereof. A rotor body is disposed between the pair of friction rings and is adapted to be mounted on a bicycle hub. The rotor body is made of light metal. The rotor body has a plurality of through holes annularly defined in an outer peripheral edge thereof and correspondingly aligned with the ventilating holes. The pair of buckles extending from at least one of the ventilating holes respectively engage with an inner periphery of the corresponding through hole such that the pair of friction rings integrally engage with the rotor body.

### BACKGROUND OF THE INVENTION

1. Field of the Invention

The present invention relates to disc brake rotor, and more particularly to a disc brake rotor having a rotor body made of light metal, two friction rings respectively disposed on two lateral surfaces of the rotor body for providing a light-weight and abrasion-resistant disc brake rotor.

2. Description of Related Art

The braking system of a bicycle is the key component for maintaining the safety for riding. Especially when riding in high speed or during competitive racing, the brake system must spontaneously respond for providing a braking effect instantly and effectively. Therefore, in order to improve the braking effect of brake systems, improvements in the sensitivities and braking force in brake levers, calipers . . . etc have been innovated. The friction force and abrasion-resistance of disc brake rotor have also been innovated for enhancing the braking effect of brake system.

A conventional disc brake rotor for bicycle comprises a disc-shape rotor mounted to the bicycle wheel hub and is driven by the bicycle wheel hub. The disc-shape rotor has an axial hole defined therein for engaging with the bicycle wheel hub. The disc-shaped rotor is made of aluminum such that the rotor is light in weight. Due to the aluminum made rotor has a smooth surface which can not provide a frictional effect, a friction layer is coated on an outer peripheral edge surface of the rotor for providing a frictional effect during operation.

However, the conventional disc brake rotor has the following drawbacks: first of all, though the conventional disc brake rotor is light in weight, the cost for coating the friction layer on the disc brake rotor is high, and therefore the cost for manufacture is increased, and the process for manufacture is complicated. Secondly, the friction layer is easily worn out through use due to the friction layer is merely a thin layer coated on the rotor, once the friction layer is worn, the frictional effect is reduced, consequently the braking effect is reduced. In view of the above, the conventional disc brake rotor is expensive to manufacture and inconvenient to use.

The present invention has arisen to obviate/mitigate the disadvantages of the conventional disc brake rotor.

### SUMMARY OF THE INVENTION

The main objective of the present invention is to provide an abrasion-resistant disc brake rotor which is light in weight, easy to assemble, and is inexpensive to manufacture.

To achieve the objective, the abrasion-resistant disc brake rotor in accordance with the present invention comprises a pair of friction rings consisted of steel. Each friction ring has a plurality of ventilating holes spacedly and annularly defined therein. At least one of the ventilating holes has a pair of buckles correspondingly protruding from an inner periphery thereof Each buckle has an extending arm horizontally protruding from the inner periphery of the ventilating hole. Each extending arm has buckling tip formed on a distal end thereof.

A rotor body is disposed between the pair of friction rings and is adapted to be mounted on a bicycle hub. The rotor body consisted of a light metal. The rotor body has a central hole centrally defined therein adapted for receivably engaging with the bicycle hub. The rotor body has a plurality of through holes annularly defined in an outer edge thereof and correspondingly aligned with the ventilating holes. A rib is formed between every two adjacent through holes. The rotor body has a plurality of vent openings defined therein for reducing weight of the rotor body.

Moreover, each friction ring has a connecting surface positioned on one side thereof for engaging with the rotor body and a friction surface positioned on another side opposite to the connecting surface and is adapted for frictionally contacting with a brake pad. Each friction ring has a thickness equals to or less than one half of a thickness of the rotor body. Each buckle outwardly protrudes from the connecting surface.

The pair of buckles of the ventilating holes respectively buckles on an inner periphery of the corresponding through hole. The extending arm of each buckle correspondingly clamping with a corresponding rib, and the buckling tip engages with the inner periphery of the through hole for buckling the friction ring on the rotor body such that the pair of friction rings are integrally attached on the rotor body. The friction rings are adheredly fixed to the rotor body by an adhesive.

In view of the above descriptions, it can be concluded that the present invention has the following advantages:

First of all, the present invention is light in weight, and yet is abrasion-resistant: the rotor body of the present invention is consisted of a light metal and has a plurality of vent openings defined therein; the steel-made friction rings are reduced in thickness, thereby a total weight of the disc brake rotor is effectively reduced. Moreover, the steel-made friction rings provides a frictional effect when operating, and yet is abrasion-resistant when frictionally contacts with the caliper.

Secondly, the present invention is easy to assemble: the friction rings are assembled with the rotor body via the pair of buckles, moreover, the friction rings are adheredly fixed to the rotor body by adhesive, such that the friction rings are conveniently and securely assembled with the rotor body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of an abrasion-resistant disc brake rotor in accordance with the present invention;

FIG. 1A is a partially enlarged perspective view of a friction ring of the abrasion-resistant disc brake rotor in accordance with the present invention;

FIG. 1B is another partially enlarged perspective view of the friction ring from another angle of the abrasion-resistant disc brake rotor in accordance with the present invention;

FIG. 2 is an assembled perspective view of the abrasion-resistant disc brake rotor in accordance with the present invention;

FIG. 2A is a partially enlarged assembled perspective view of the abrasion-resistant disc brake rotor in accordance with the present invention;

FIG. 3 is a cross-sectional view taken along segment 3-3 of FIG. 2; and

FIG. 4 is a cross-sectional view taken along segment 4-4 of FIG. 2.

### DETAILED DESCRIPTION OF THE INVENTION

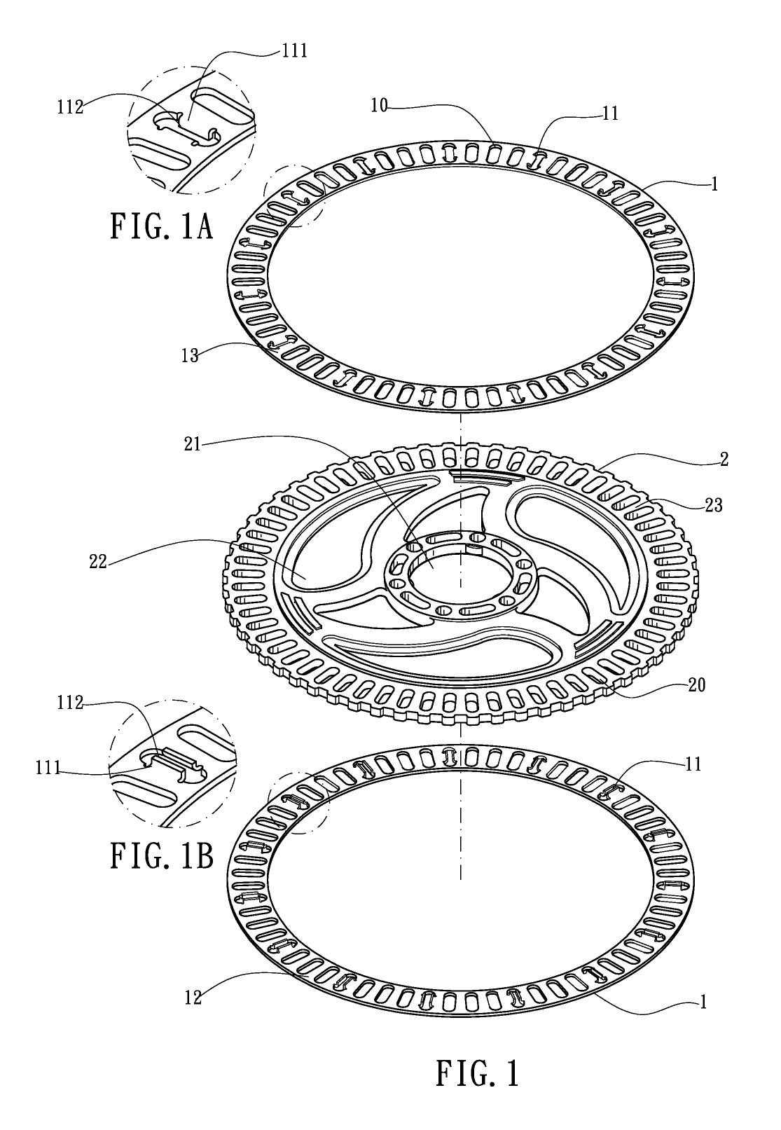

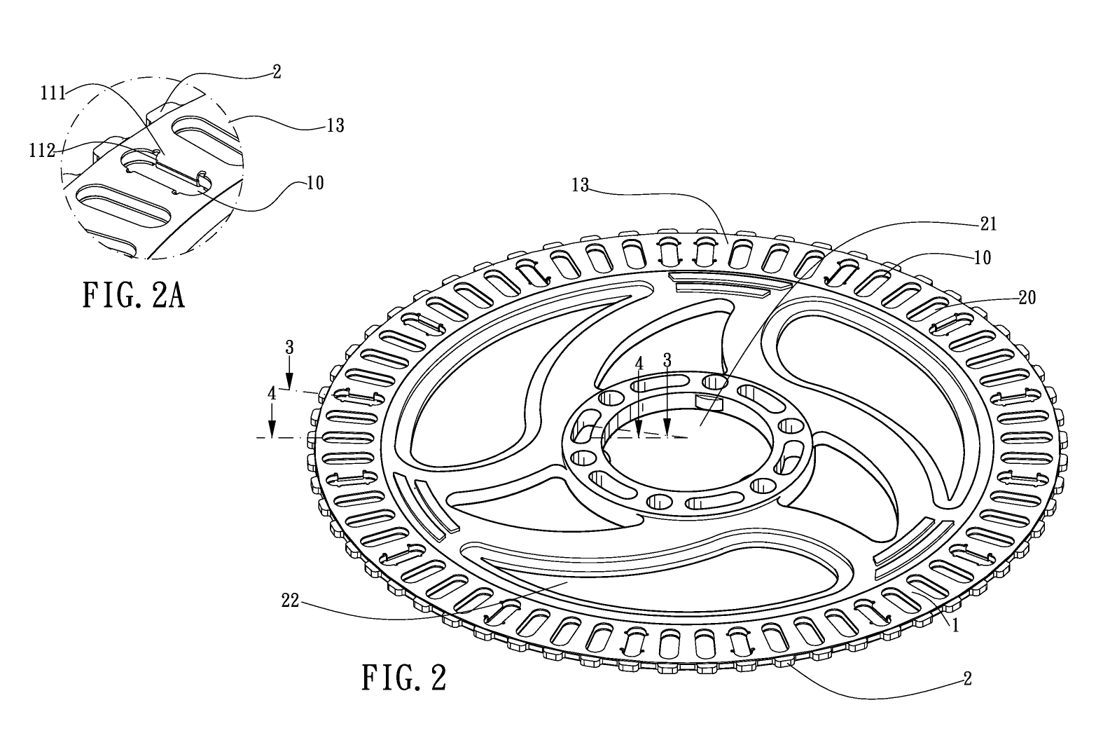

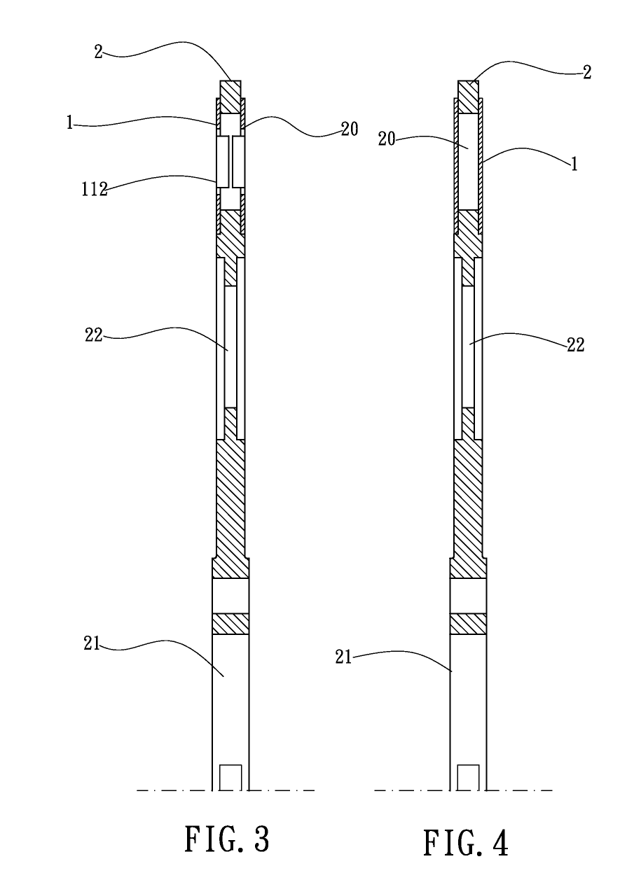

Referring to the drawings and initially to FIGS. 1-4, an abrasion-resistant disc brake rotor in accordance with the present invention comprises a pair of friction rings 1 consisted of steel such as stainless. Each friction ring 1 has a plurality of ventilating holes 10 spacedly and annularly defined therein. At least one of the ventilating holes 10 has a pair of buckles 11 correspondingly protruding outward from an inner periphery thereof. In the preferred embodiment, the pairs of buckles 11 are alternately arranged in the ventilating holes 10. Each buckle 11 has an extending arm 111 horizontally protruding from the inner periphery of the ventilating hole 10. Each extending arm 111 has a buckling tip 112 formed on a distal end thereof.

A rotor body 2 is disposed between the pair of friction rings 1 and is adapted to be mounted on a bicycle hub (not shown). The rotor body 2 is consisted of a light metal such as aluminum. The rotor body 2 has a central hole 21 centrally defined therein adapted for receivably engaging with the bicycle hub. The rotor body 2 has a plurality of through holes 20 annularly defined in an outer edge thereof and correspondingly aligned with the ventilating holes 10. A rib 23 is formed between every two adjacent through holes 20. The rotor body 2 has a plurality of vent openings 22 defined therein such that the weight of the rotor body 2 is reduced.

Moreover, each friction ring 1 has a connecting surface 12 positioned on one side thereof for engaging with the rotor body 2 and a friction surface 13 positioned on another side opposite to the connecting surface 12 and is adapted for contacting with a brake pad (not shown). Each friction ring 1 has a thickness equals to or less than one half of a thickness of the rotor body 2. Each buckle 11 outwardly protrudes from the connecting surface 12.

When assembling the pair of friction rings 1 with the rotor body 2, adhesive is firstly applied on either the rotor body 2 or the connecting surface 12 of each friction ring 1, then correspondingly aligning each ventilating hole 10 of each friction ring 1 with each through hole 20 of the rotor body 2, such that the pairs of buckles 11 respectively buckle on an inner periphery of the corresponding through hole 20. The extending arm 111 of each buckle 11 correspondingly clamping with a corresponding rib 23, and the buckling tip 112 engages with the inner periphery of the corresponding through hole 20 for buckling the friction ring 1 on the rotor body 2 such that the pair of friction rings 1 are integrally attached on and adheredly fixed to the rotor body 2.

In view of the above description, it can be concluded that, the abrasion-resistant disc brake rotor in accordance with the present invention is easy to assemble: by applying adhesive on the rotor body 2 or the friction rings 1, and by buckling the friction rings 1 on the rotor body 2 via the pairs of buckles 11, the rotor body 2 and the friction rings 1 are tightly and securely fixed. Moreover, the friction surfaces 13 of the friction rings 1 provide frictional effects when frictionally contacting with the brake pad, such that a braking effect is enhanced. Furthermore, the friction rings 1 consisted of steel are not worn easily when frictionally contacting with the brake pads during operation, such that a usage life is prolonged.

Although the invention has been explained in relations to its preferred embodiment, it is to be understood that many other possible modifications and variations can be made without departing from the spirit and scope of the invention as hereinafter claimed.

What is claimed is:

1. An abrasion-resistant disc brake rotor comprising:
a pair of friction rings consisted of steel, each friction ring having a plurality of ventilating holes spacedly and annularly defined therein; at least one of the ventilating holes having a pair of buckles correspondingly protruding from an inner periphery thereof;
a rotor body disposed between the pair of friction rings and adapted to be mounted on a bicycle hub, the rotor body consisted of a light metal, the rotor body having a plurality of through holes annularly defined in an outer edge thereof and correspondingly aligned with the ventilating holes;
wherein the pair of buckles of the ventilating holes respectively buckled on an inner periphery of the corresponding through hole such that the pair of friction rings integrally attached on the rotor body.

2. The abrasion-resistant disc brake rotor as claimed in claim 1, wherein each friction ring has a connecting surface positioned on one side thereof for engaging with the rotor body and a friction surface positioned on another side opposite to the connecting surface adapted for frictionally contacting with a brake pad; each buckle outwardly protruding from the connecting surface.

3. The abrasion-resistant disc brake rotor as claimed in claim 1, wherein the rotor body has a central hole centrally defined therein adapted for receivably engaging with the bicycle hub; a rib formed between every two adjacent through holes;
each buckle having an extending arm horizontally protruding from the inner periphery of the ventilating hole for correspondingly clamping with a corresponding rib; each extending arm having a buckling tip integrally formed on a distal end thereof for engaging with the inner periphery of the corresponding through hole for buckling the friction ring on the rotor body.

4. The abrasion-resistant disc brake rotor as claimed in claim 1, wherein each friction ring has a thickness equals to or less than one half of a thickness of the rotor body.

5. The abrasion-resistant disc brake rotor as claimed in claim 1, wherein the rotor body has a plurality of vent openings defined therein and extending therethrough for reducing weight of the rotor body.

6. The abrasion-resistant disc brake rotor as claimed in claim 1, wherein the friction rings are adheredly fixed to the rotor body by an adhesive.
